(19) United States
(12) Patent Application Publication
(10) Pub. No.: US 2022/0388345 A1
(43) Pub. Date: Dec. 8, 2022

(54) TIRE HAVING A TREAD

(71) Applicant: COMPAGNIE GENERALE DES ETABLISSEMENTS MICHELIN, Clermont-Ferrand (FR)

(72) Inventors: BERTRAND BOISDON, Clermont-Ferrand (FR); JEROME LABROUSSE, Clermont-Ferrand (FR); MARIE-HELENE VANTAL, Clermont-Ferrand (FR)

(21) Appl. No.: 17/774,947

(22) PCT Filed: Nov. 6, 2020
(86) PCT No.: PCT/FR2020/052018

§ 371 Date: May 6, 2022

(30) Foreign Application Priority Data
Nov. 6, 2019 (FR) 1912462

(51) Int. Cl. B60C 11/03; B60C 11/12

(52) U.S. Cl. CPC B60C 11/0302; B60C 11/1281; B60C 11/1204; B60C 11/1236; B60C 2011/0374; B60C 2011/1213

(57) ABSTRACT

A tire comprises a directional tread which forms a contact patch AC during running. The tread comprises a plurality of blocks (21A, 21B) which form a contact surface SC. The surface voids ratio is defined by TES=(AC−SC)/AC. The blocks (21A, 21B) are organized into patterns (26) of blocks of pitch P which succeed one another in the circumferential direction (X), in a pattern comprising at least one sipe. The sipes density is defined by the formula

$$SD = \frac{{\sum }_{i = 1}^{n} lpyi}{P * W} * 1000 ,$$

where n is the number of sipes, lpyi is the projected distance of the sipe i in the axial direction (Y), and W is the width of the tread. Simultaneously, SD is at least equal to 10 mm-1 and at most equal to 70 mm-1, and TES is at least equal to 0.40 and at most equal to 0.70.

### TECHNICAL FIELD

The present invention relates to a tyre for any motor vehicle, known as an “all season” tyre. The invention is more particularly suited to a tyre intended to be fitted to a passenger vehicle or van.

### PRIOR ART

As is known, a tyre known as an “all-season” tyre is a tyre which offers an excellent compromise between grip on snowy ground/wet ground while still maintaining good performance on dry ground. These tyres are intended to run safely all the year round, whatever the weather. They have generally attained the 3PMSF (3 Peak Mountain Snow Flake) winter certification attesting to their excellent performance on snowy ground and on wet ground. This certification is notably indicated on one or both of the sidewalls of this type of tyre.

Document WO2016/134988 discloses an all-season tyre having a tread comprising two edges and a centre. Said tread is directional and comprises a plurality of blocks of rubbery material. More particularly, each block of the plurality of blocks has a central zone extending overall over an angle β1, said angle β1 being at least greater than 35 degrees and at most less than 65 degrees to an axial direction. Each block of the plurality of blocks also has an edge zone extending overall over an angle β3 at least greater than 0 degrees and at most less than 10 degrees to said axial direction. Finally, each block of the plurality of blocks has an intermediate zone between the central zone and the edge zone of the block, said intermediate zone making an angle β2 with said axial direction.

There is an ever-present need to improve the performance of all-season tyres both with regard to the compromise between grip on snowy ground and grip on wet ground and with regard to grip on dry ground and more particularly grip under braking on dry ground.

### DISCLOSURE OF THE INVENTION

The present invention seeks to at least partially meet this need.

More specifically, the present invention seeks to improve the compromise between grip on snowy ground/wet ground for an all-season tyre while at the same time improving the performance in terms of grip on dry ground.

The invention relates to a tyre comprising a tread.

A “tyre” means all types of tyre casing made of a rubbery material and which, during running is subjected to an internal pressure or not subjected to such an internal pressure during running (which is the case of an airless tyre, for example of the Tweel™ type).

More particularly, the invention relates to a tyre comprising a directional tread of width W. This tread is intended to come into contact with the ground during running of the tyre, forming a contact patch AC. The tread comprises a plurality of blocks of rubbery material delimited by voids. Some of these blocks form a contact surface SC of the blocks in the contact patch AC. The ratio of the difference between the contact patch AC and the contact surface of the blocks SC on this contact patch AC to said contact patch AC determines a surface voids ratio TES of the tread, where TES=(AC−SC)/AC. For a tread when new, the surface voids ratio TES is at least equal to 0.40 and at most equal to 0.70. The blocks are organized into patterns of blocks of pitch P succeeding one another in the circumferential direction. Part of the plurality of voids forms one or more sipes in one of the patterns at a sipes density SD. This sipes density SD corresponds to the ratio of a sum of the projected length(s) of the sipe(s) in an axial direction to the product of the pitch P of the pattern times the width W of the tread, all multiplied by 1000, such that

$$SD = \frac{{\sum }_{i = 1}^{n} lpyi}{P * W} * 1000 ,$$

where n is the number of sipes in the pattern, and lpyi is the projected length of the ith sipe. For the tread when new, the sipes density SD in any pattern of pitch P is at least equal to 10 mm⁻¹ and at most equal to 70 mm⁻¹.

The combination of these features makes it possible to obtain a tyre offering an excellent compromise between grip on snowy ground and grip on wet ground while at the same time improving the performance in terms of grip on dry ground and more particularly the grip when braking on dry ground.

Preferentially, the surface voids ratio TES is greater than or equal to 0.45.

Preferentially, the surface voids ratio TES is greater than or equal to 0.50, and preferentially greater than 0.55.

In one preferred embodiment, the surface voids ratio TES decreases with the depth of the tread.

In one preferred embodiment, the surface voids ratio TES of the tread worn away by 2 mm of depth is at least equal to 0.41 times the TES when new and at most equal to 0.66 times said TES when new.

Preferentially, the surface voids ratio TES of the tread worn away by 2 mm of depth is at least equal to 0.5 times the TES when new and at most equal to 0.58 times said TES when new.

In an embodiment variant, the tread comprises different pattern types Mj, where j is greater than or equal to 2, the patterns belonging to the one same pattern type having the one same pitch, the pitch between patterns belonging to two different respective pattern types being different, and in that the mean sipes density SDmean over the entire circumference of the tyre is at least equal to 10 mm⁻¹ and at most equal to 70 mm⁻¹, said mean sipes density SDmean corresponding to the mean of the sipes densities SDj of the patterns of the different pattern types Mj of pitch Pj over the entire circumference of the tread, said mean sipes density SDmean being weighted according to the number of patterns Nj per pattern type Mj and according to the pitch Pj of the patterns belonging to the pattern type Mj over said circumference of the tread, such that

$$SD mean = \frac{{\sum }_{j = 1}^{m} ( SDj * Nj * Pj )}{{\sum }_{j = 1}^{m} ( Nj * Pj )}$$

where m is the number of different pattern types, SDj is the sipes density in a pattern belonging to the pattern type Mj, Pj is the pitch of the patterns belonging to the pattern type Mj, and Nj is the number of patterns belonging to the pattern type Mj, when said tread is new.

Preferentially, the sipes density SD or the mean sipes density SDmean is at least equal to 25 mm⁻¹.

Preferentially, the sipes density SD or the mean sipes density SDmean is at least equal to 30 mm⁻¹.

Preferentially, the sipes density SD or the mean sipes density SDmean is at least equal to 35 mm⁻¹.

Preferentially, the sipes density SD or the mean sipes density SDmean is at least equal to 40 mm⁻¹.

Preferentially, the sipes density SD or the mean sipes density SDmean is at least equal to 45 mm⁻¹.

Preferentially, the sipes density SD or the mean sipes density SDmean is at most equal to 60 mm⁻¹.

Preferentially, the sipes density SD or the mean sipes density SDmean is at most equal to 50 mm⁻¹.

In a preferred embodiment, in the tread when new, the blocks have a maximum height at least equal to 5.5 mm and at most equal to 9 mm, and preferably at most equal to 7.5 mm. By reducing the radial height of the block, the overall rolling resistance of the tyre is improved, as well as the roadholding on dry ground.

The blocks are made of rubbery material.

What is meant by a “rubbery material” is a polymeric material of the elastomeric compound type, that is to say a polymeric material obtained by mixing at least one elastomer, at least one reinforcing filler and a crosslinking system.

A conventional physical characteristic of an elastomeric compound is its glass transition temperature Tg, the temperature at which the elastomeric compound passes from a deformable rubbery state to a rigid glassy state. The glass transition temperature Tg of an elastomeric compound is generally determined during the measurement of the dynamic properties of the elastomeric compound, on a viscosity analyser (Metravib VA4000), according to the standard ASTM D 5992-96. The dynamic properties are measured on a sample of vulcanized elastomeric compound, that is to say elastomeric compound that has been cured to a degree of conversion of at least 90%, the sample having the form of a cylindrical test specimen having a thickness equal to 2 mm and a cross-sectional area equal to 78.5 mm². The response of the sample of elastomeric mixture to a simple alternating sinusoidal shear stress, having a peak-to-peak amplitude equal to 0.7 MPa and a frequency equal to 10 Hz, is recorded. A temperature sweep is carried out at a constant rate of rise in temperature of +1.5° C./min. The results utilized are generally the complex dynamic shear modulus G*, comprising an elastic part G′ and a viscous part G″, and the dynamic loss tan δ, equal to the ratio G″/G′. The glass transition temperature Tg is the temperature at which the dynamic loss tan δ reaches a maximum during the temperature sweep. The value of G* measured at 60° C. is indicative of the stiffness of the rubbery material, namely of its resistance to elastic deformation.

In one preferred embodiment, the composition of the rubbery material of the blocks of the pattern has a glass transition temperature Tg comprised between −40° C. and −10° C. and preferably between −35° C. and −15° C. In addition, the composition of the rubbery material has a dynamic shear modulus measured at 60° C. comprised between 0.5 MPa and 2 MPa, and preferably between 0.7 MPa and 1.5 MPa.

As far as the chemical composition is concerned, the elastomer compound of the block or blocks according to the invention contains 100 phr (parts per hundred rubber) of an elastomer matrix containing a modified diene elastomer. A diene elastomer is, by definition, a homopolymer or a copolymer resulting at least in part from diene monomers, i.e. from monomers bearing two carbon-carbon double bonds which may or may not be conjugated. As a preference, the elastomer compound contains the modified diene elastomer at a content at least equal to 20 phr.

The modified diene elastomer according to the invention contains at least one functional group comprising a silicon atom, the latter being situated within the main chain, including the ends of the chain. What is meant here by an “atom situated within the main chain of the elastomer, including the ends of the chain” is an atom that is not an atom hanging down from (or a lateral atom in) the main chain of the elastomer but is an atom that is integrated into the main chain. In a preferred embodiment, the composition of the block comprises an elastomer compound, said elastomer compound containing a modified diene elastomer containing at least one functional group comprising a silicon atom, the latter being situated within the main chain of the elastomer, including the ends of the chain.

Preferentially, the modified diene elastomer comprises a functional group containing a silicon atom at one end of the main chain of the elastomer.

Preferentially, the functional group contains a silanol functional group. As a variant, the silicon atom of the functional group is substituted by at least one alkoxy functional group which may potentially have been fully or partially hydrolysed to hydroxyl.

In an embodiment variant, the functional group is situated in the main elastomer chain and the diene elastomer can then be said to be coupled or else functionalized in the middle of the chain. The silicon atom of the functional group therefore bonds the two branches of the main chain of the diene elastomer. The silicon atom of the functional group is substituted by at least one alkoxy functional group which may potentially have been fully or partially hydrolysed to hydroxyl.

According to the invention variants whereby the functional group comprises a silanol functional group at the end of the chain, the functional group may be a silanol functional group or else a polysiloxane group having a silanol end. Corresponding modified diene elastomers are notably described in documents EP 0 778 311 A1, WO 2011/042507 A1.

According to any one of the invention variants whereby the silicon atom of the functional group is substituted by at least one alkoxy functional group which may potentially have been fully or partially hydrolysed to hydroxyl, the silicon atom may also be substituted, directly or via a divalent hydrocarbon radical, by at least one other functional group containing at least one heteroatom selected from N, S, O, P. As a preference, the silicon atom is substituted by at least one other functional group via a divalent hydrocarbon radical, more preferably a C1-C18 linear aliphatic one. Included amongst these other functional groups, mention may, by way of example, be made of primary, secondary or tertiary amines, cyclic or non-cyclic, isocyanates, imines, cyanos, thiols, carboxylates, epoxides, and primary, secondary or tertiary phosphines. The other functional group is preferably a tertiary amine, more preferentially a diethylamino- or dimethylamino-group. The alkoxy functional group is preferably a methoxy, ethoxy, butoxy or propoxy functional group. Modified diene elastomers corresponding to these variants are notably described in documents WO 2009/133068 A1, WO 2015/018743 A1.

The modification of the diene elastomer by at least one functional group containing a silicon atom does not exclude another modification of the elastomer for example at the end of the chain by an amine functional group introduced at the time of initiation of polymerization, as described in WO 2015/018774 A1, WO 2015/018772 A1.

As a preference, the modified diene elastomer according to the invention is a 1,3-butadiene polymer, more preferably a 1,3-butadiene/styrene copolymer (SBR).

The modified diene elastomer according to the invention may, according to different variants, be used alone in the elastomeric compound or as a blend with at least one other diene elastomer conventionally used in tyres, whether it is star-branched, coupled, functionalized, for example with tin or with silicon, or not.

Likewise from the viewpoint of its chemical composition, the elastomeric compound of the tread according to the invention comprises a plasticizing resin of the thermoplastic resin type at a content at least equal to 20 phr.

In one variant embodiment of the invention, the tyre has a 3PMSF winter certification, said certification being indicated on a sidewall of the tyre.

The present invention will be understood better upon reading the detailed description of embodiments that are given by way of entirely non-limiting examples and are illustrated by the appended drawings, in which:

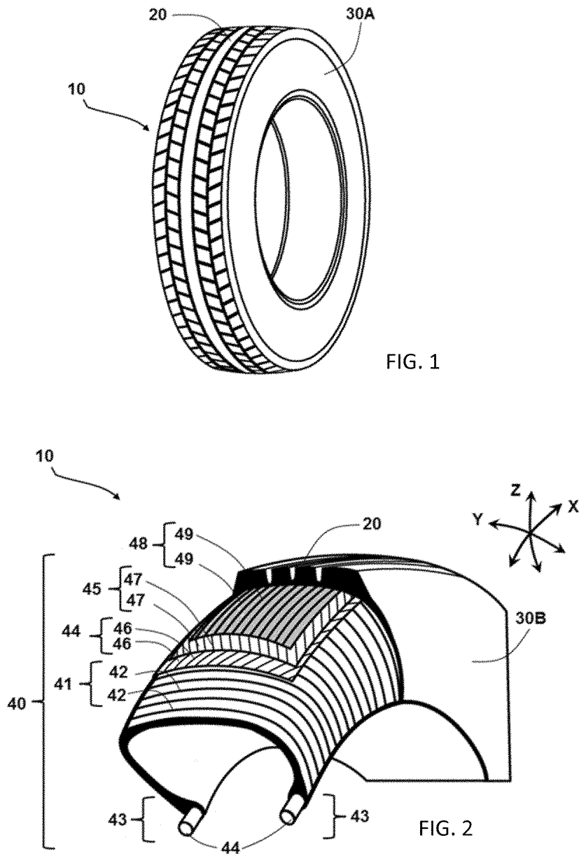

FIG. 1 is a schematic perspective view of a tyre according to the prior art;

FIG. 2 is a schematic perspective view of a partial cross section of a tyre according to another prior art;

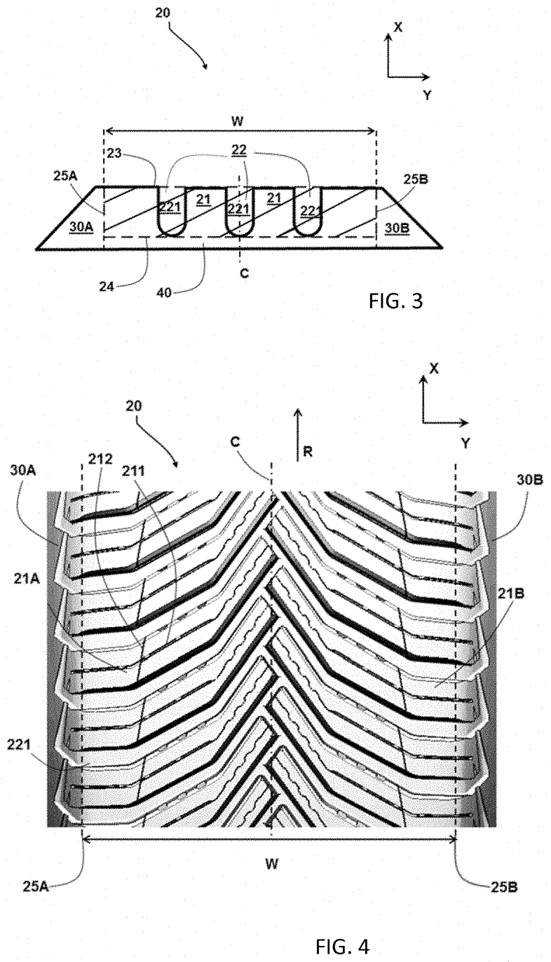

FIG. 3 is a view in cross section of the tread of the tyre of FIG. 2;

FIG. 4 is a detailed partial view of a tread, when new, of a tyre according to a first embodiment of the invention;

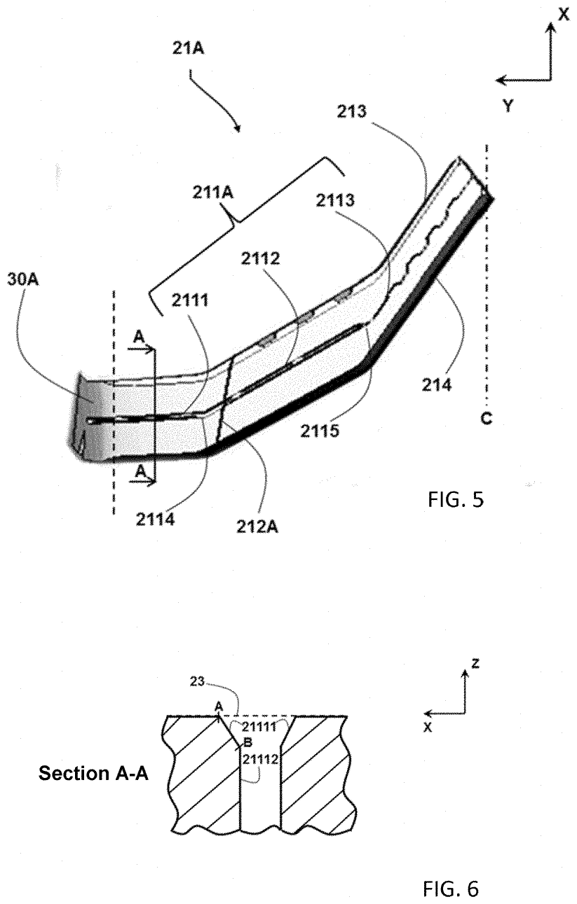

FIG. 5 is an enlarged view of a block of the tread of FIG. 4;

FIG. 6 is view in cross section on the plane of section A-A of FIG. 5;

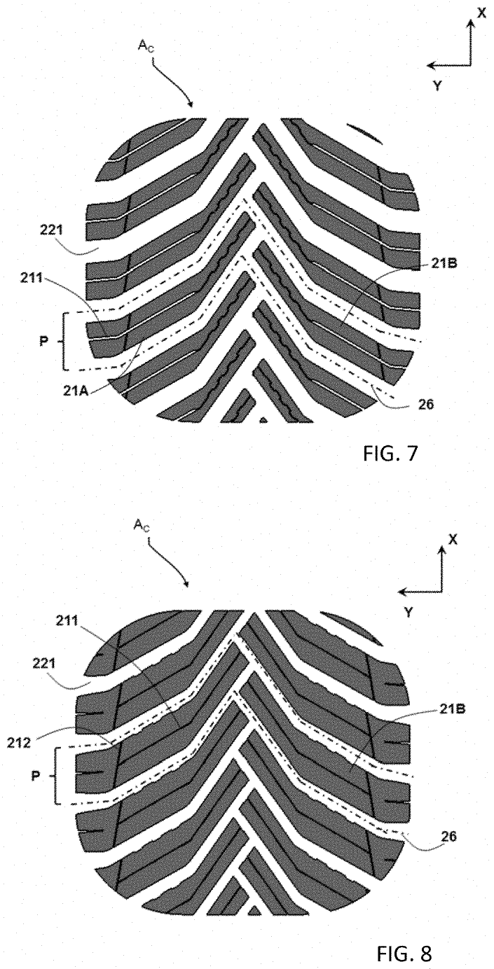

FIG. 7 is a schematic view of a contact patch of the tread, when new, of the tyre of FIG. 4;

FIG. 8 is a schematic view of a contact patch of the tread, when worn, of the tyre of FIG. 4;

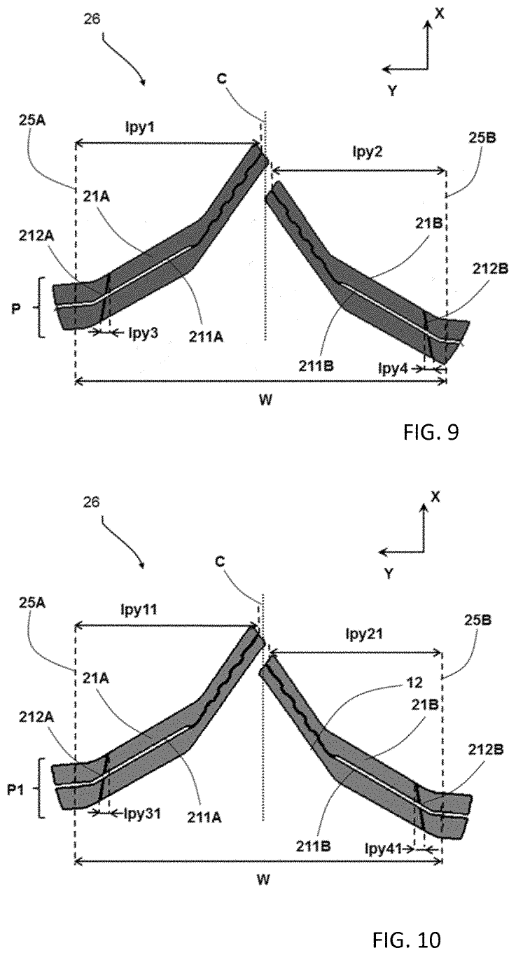

FIG. 9 is part of the contact patch of FIG. 7, centred on one pattern of the tread;

FIG. 10 is an enlarged view of a collection of blocks belonging to a pattern of pitch P1 of a tread of a tyre according to a second embodiment of the invention;

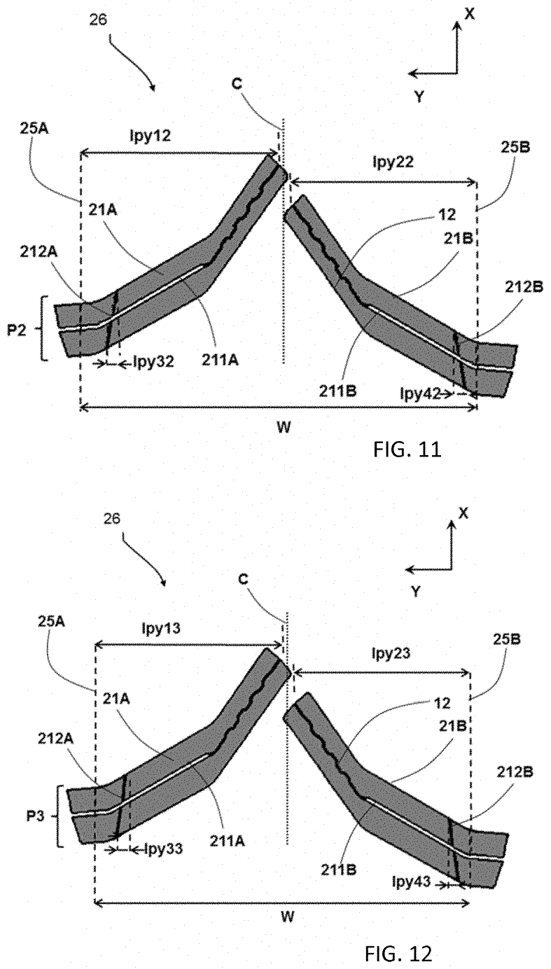

FIG. 11 is an enlarged view of a collection of blocks belonging to a pattern of pitch P2 of a tread of a tyre according to the second embodiment of the invention;

FIG. 12 is an enlarged view of a collection of blocks belonging to a pattern of pitch P3 of a tread of a tyre according to the second embodiment of the invention.

The invention is not limited to the embodiments and variants presented and other embodiments and variants will become clearly apparent to a person skilled in the art.

In the various figures, identical or similar elements bear the same references. Thus, the references used to identify elements on the tread are used again to identify these same elements on the contact patch created from said tread.

FIG. 1 schematically depicts a tyre 10 according to the prior art. This tyre 10 comprises a tread 20 and two sidewalls 30A, 30B (of which just one is depicted here), said tread 20 and said sidewalls 30A, 30B covering a carcass 40 (which is not depicted in FIG. 1). FIG. 2 more particularly details the carcass 40 of a tyre 10 according to the prior art. This carcass 40 thus comprises a carcass reinforcement 41 made up of threads 42 coated with rubber composition, and two beads 43 each comprising annular reinforcing structures 44 (in this instance bead wires) which hold the tyre 10 on a rim (the rim is not depicted). The carcass reinforcement 41 is anchored in each of the beads 43. The carcass 40 additionally comprises a crown reinforcement comprising two working plies 44 and 45. Each of the working plies 44 and 45 is reinforced by filamentary reinforcing elements 46 and 47 which are parallel within each layer and crossed from one layer to the other, making angles comprised between 10° and 70° with the circumferential direction X.

What is meant by a “circumferential direction” is a direction that is tangential to any circle centred on the axis of rotation. This direction is perpendicular both to an axial direction and to a radial direction.

What is meant by a “radial direction” is a direction which is perpendicular to the axis of rotation of the tyre (this direction corresponds to the direction of the thickness of the tread at the centre of said tread).

What is meant by an “axial direction” is a direction parallel to the axis of rotation of the tyre.

The tyre further comprises a hoop reinforcement 48 arranged radially on the outside of the crown reinforcement. This hoop reinforcement 48 is formed of reinforcing elements 49 that are oriented circumferentially and wound in a spiral. The tyre 10 depicted in FIG. 2 is a “tubeless” tyre. It comprises an “inner liner” made of a rubber composition impervious to the inflation gas, covering the interior surface of the tyre.

FIG. 3 is a detailed view in cross section of the tread 20 of FIG. 2. The tread provides contact between the tyre 10 and the road. For that purpose it comprises blocks 21 made of a rubbery material, and voids 22 delimiting said blocks 21. The blocks 21 constitute the solid part of the tread 20 and the voids 22 constitute the hollow part of this same tread 20.

What is meant by “voids” are the various types of cuts, for example grooves, sipes or any other kinds of cut.

What is meant by a “groove” is a void for which the distance between the walls of material that delimit same is greater than 2 mm and of which the depth is greater than or equal to 1 mm.

What is meant by a “sipe” is a void for which the distance between the walls of material that delimit same is less than or equal to 2 mm and of which the depth is greater than or equal to 1 mm.

The other types of cuts may, for example, include “V-shaped grooves”, namely voids of a depth less than 1 mm.

What is meant by a “block” is a raised element delimited by grooves and comprising lateral walls and a contact face, the latter being intended to come into contact with the ground during running.

What is meant by a “tread surface” 23 of a tread 20 is the surface that groups together all the points of the tyre that will come into contact with the ground under normal running conditions. These points that will come into contact with the ground belong to the contact faces of the blocks 21. In FIG. 3, the tread surface 23 is deliberately extended over the voids 22 in order to ensure its continuity between the two edges 25A and 25B. For a tyre, the “normal running conditions” are the use conditions defined by the ETRTO (European Tyre and Rim Technical Organisation) standard. These use conditions specify the reference inflation pressure corresponding to the load-bearing capacity of the tyre as indicated by its load index and its speed rating. These use conditions can also be referred to as “nominal conditions” or “working conditions”.

What is meant by “bottom surface” 24 is a theoretical surface passing through the radially interior points of the grooves 221 of the tread 20. It thus delimits the boundary between the tread 20 and the carcass 40 of the tyre. This bottom surface 24 extends between a first edge 25A and a second edge 25B of the tread 20.

What is meant by an “edge” 25A, 25B of the tread 20 is the surfaces that delimit the boundaries between the tread 20 and the sidewalls 30. These two edges 25A, 25B extend radially and are distant from one another by a value W corresponding to the width of the tread 20. These two edges 25A, 25B are situated at equal distances from a central axis C. This central axis C divides the tread 20 into two half-treads.

The tread 20 in FIG. 3 here comprises three grooves 221. These grooves 221 extend circumferentially in the tread, forming a voids volume VE.

The tread 20 is delimited by a tread surface 23, a bottom surface 24, a first edge 25A and a second edge 25B. The total volume VT of this tread corresponds to the volume that a rubbery material between these various limits (the tread surface 23, the bottom surface 24, the edges 25A, 25B) would occupy in the theoretical scenario of this tread having no voids. Thus, the following relationship VT=VE+VC holds, where VC is the volume of rubber actually contained in the tread.

One means for determining the total volume VT of the tread would be to calculate a total surface area ST of this tread in a radian or meridian plane and to multiply it by the perimeter of the tyre. The area of such a total surface ST is notably depicted by hatching in FIG. 3. This total surface ST is therefore delimited by the tread surface 23, the bottom surface 24, a first edge 25A and a second edge 25B.

Systems for obtaining data pertaining to the surface of the tread in order to determine the map of this tread surface are known. For example, laser mapping systems have been used to obtain data measurement points for points on the surface of a tyre. Such a process is notably described in documents WO2015016888 and EP2914946. Laser mapping systems typically comprise a laser probe used to measure the distance from the probe to the surface of the tread of the tyre for each point along the surface of the tyre. This laser probe may be any suitable device for acquiring data associated with the tread (for example the height of this tread) using a laser, such as a laser probe used in a WOLF & BECK TMM-570 metrology machine. It is then possible to numerically simulate the contours of the tread surface 23 and of the bottom surface 24 by laser scanning. Thus, the tread surface 23 is obtained from points measured on the contact faces of the blocks. The bottom surface 24 is obtained from points measured in the bottom of the grooves 221. The first edge 25A and the second edge 25B are obtained by knowing the width W of the tread. This width W may be obtained by a making an inked impression of the tread under normal running conditions. The simulation of the tread surface 23, of the bottom surface 24 and the determination of the edges 25A, 25B allow the total area of the surface ST of the tread to be calculated. The area of said surface ST is depicted by hatching in FIG. 3.

The perimeter of the tyre is obtained by multiplying a mean radius of curvature Rc in the median circumferential plane or equatorial plane of this tyre by 2*π. The mean radius of curvature Rc is the radius which has as its origin the axis of rotation of the tyre and which passes through the middle of the surface of the tread. From the area of the total surface ST and from the perimeter of the tyre it is then possible to deduce the total volume VT of the tread.

The volumetric voids ratio TEV corresponds to the ratio of the voids volume VE to the total volume VT, such that TEV=VE/VT. Now, given that VE=VT−VC, the relationship TEV=1−(VC/VT) can be deduced. The volume of rubber VC contained in the tread can be determined as follows:
the tyre is weighed when new;
this tyre is then planed down until a maximum state of wear is reached, namely until the bottom surface 24 is reached;
the planed tyre is weighed;
the difference in mass between the tyre when new and the tyre when worn gives the mass of rubbery material actually contained in the tread;
the volume of rubber VC is determined from the mass of rubbery material contained in the tread and from the density of this rubbery material.

The volume of rubber VC and the total volume VT make it possible to determine the volumetric voids ratio TEV.

Another method for determining a volumetric voids ratio TEV would be to make full use of the capabilities of the laser measurement means such as those disclosed in document FR2996640. These measurement means comprise a beam having an axis directed at a tangent to the surface of the central zone of the tread of the tyre and/or to the surface of at least one lateral zone of this tread. Using these measurement means, various exterior profiles around the entire circumference of the tyre are created. Superposing these exterior profiles on the one same meridian allows a crown profile and a bottom profile to be determined. It is then possible to construct a total surface bounded by the crown profile and the bottom profile and by planes delimiting the tread. These planes delimiting the tread are planes normal to the crown profile determining the width of tread in contact with the ground under nominal pressure and load conditions according to the ETRTO. For each exterior profile obtained by laser scanning, a surface area, with voids, and which is bounded by the exterior profile, the bottom profile and the planes delimiting the tread, is constructed.

A parameter TEMeridianₙ corresponding to a meridian voids ratio in a meridian plane n is defined, where

$${TEMeridian}_{n} = 1 - \frac{area of voids}{total area} .$$

It is then possible to determine the volumetric voids ratio TEV as being the mean of the meridian voids ratios, where

$$TEV = \frac{{\sum }_{i = 1}^{N} {TEMeridian}_{i}}{{\sum }_{i = 1}^{N} {n}_{i}} .$$

The volumetric voids ratio can also be determined using other methods known to those skilled in the art.

FIG. 4 is a detailed view of part of a tread 20 according to the invention. The tread 20 here is as new. It comprises a plurality of blocks 21A, 21B which extend respectively from one of the edges 25A, 25B of the tread 20 as far as the central axis C with a certain curvature. The central axis C thus comprises an alternation of blocks 21A, 21B originating from the edges 25A, 25B of the tread 20. The tread 20 here is said to be directional, which means to say that the blocks 21A, 21B are specifically arranged to optimize the behavioural characteristics depending on a predetermined sense of rotation. This sense of rotation is conventionally indicated by an arrow on the sidewall of the tyre (arrow labelled R in FIG. 4). It will be noted that the blocks have a maximum height at least equal to 5.5 mm and at most equal to 9 mm. As a preference, the maximum height of the blocks is at most equal to 7.5 mm. This maximum height is measured for the blocks at the central axis C. It corresponds to the distance between the tread surface 23 and the bottom surface 24 at this location. The maximum height of a block corresponds to the maximum depth of the grooves delimiting this block.

FIG. 5 more specifically illustrates one of the blocks 21A of the plurality of blocks. The description hereinbelow applies more particularly to a first block 21A. This description may also apply to any block 21A, 21B of the plurality of blocks of the tread 20. The block 21A comprises a main sipe 211A and a secondary sipe 212A. It also comprises a first chamfered zone 213 and a second chamfered zone 214 on two main lateral walls of the block 21A.

The main sipe 211A starts at one of the sidewalls 30A and extends as far as the central axis C. This main sipe 211A is divided into a first sipe part 2111, a second sipe part 2112 and a third sipe part 2113. The first sipe part 2111 and the second sipe part 2112 are connected together at a first connecting point 2114. The second sipe part 2112 and the third sipe part 2113 are connected together at a second connecting point 2115. The first sipe part 2111 thus extends between the sidewall 30A and the first connecting point 2114. More particularly, this first sipe part 2111 forms a rectilinear trace on the tread surface between the sidewall 30A and the first connecting point 2114. This trace runs generally parallel to the direction Y. As illustrated in FIG. 6, the first sipe part 2111 comprises two inclined planes 21111. These inclined planes 21111 form chamfers on the tread 20. The chamfers improve grip on dry ground, and more particularly braking on such ground Each inclined plane 21111 extends between a first point A and a second point B. The first point A corresponds to the intersection between the inclined plane 21111 and the tread surface 23 of the tread. The second point B corresponds to the intersection between the inclined plane 21111 and a lateral wall 21112 delimiting the sipe 211A. The inclined plane 21111 is defined by a height, a width and by an angle of inclination with respect to the circumferential direction X. The height of the inclined plane corresponds to the distance between the first point A and the second point B in a radial projection, which is to say in a projection onto the axis Z. The height of the inclined plane here is comprised between 0.5 and 1 mm. The width of the inclined plane corresponds to the distance between the first point A and the second point B in a circumferential projection, which is to say in a projection onto the axis X. The width of the inclined plane here is comprised between 1.5 and 2 mm. The angle of inclination of the inclined part is comprised between 30 degrees and 50 degrees with respect to the circumferential direction X. The second sipe part 2112 extends between the first connecting point 2114 and the second connecting point 2115. More particularly, this second sipe part 2112 forms a rectilinear trace on the tread surface between the first connecting point 2114 and the second connecting point 2115. This trace makes an angle of around 30 degrees with the axial direction Y. The second sipe part 2112 also comprises two inclined planes forming chamfers on the tread 20. The third sipe part 2113 extends between the second connecting point 2115 and an end of the block 21A near the central axis C. More particularly, the third sipe part 2113 forms a wavy trace on the tread surface between said second connecting point 2115 and the end of the block 21A. This wavy trace extends in a main direction that makes an angle of around 45 degrees with the axial direction Y. The third sipe part 2113 here has no inclined planes forming chamfers. The block 21A also comprises a secondary sipe 212A. This secondary sipe 212A forms a rectilinear trace on the tread surface that intersects the main sipe 211A at the second sipe part 2112 thereof. The secondary sipe 212A makes an angle of around 80 degrees with the axial direction Y. Finally, the main lateral walls of the block 21A also comprise inclined planes 213 and 214 which form chamfers.

FIG. 7 is a schematic view, at an instant T, of a contact patch AC via which the tread of the tyre of FIG. 4 is in contact with the ground. What is meant by the “contact patch” is the area of the surface formed by the tyre with the ground at this instant T. It is through this contact patch that all the mechanical loads pass between the vehicle and the ground. All of the contact patches determined at different instants makes it possible to reconstruct a picture of the tread surface of the tread. The contact patch here is substantially rectangular with rounded contour portions. This contact patch contains both the contact surfaces SC of the blocks (which are the solid areas shown in grey in FIG. 7) and the areas occupied by the voids (the blank areas shown in white in FIG. 7).

The difference between the area of the contact patch AC and the area of the contact surface SC of the blocks makes it possible to determine a surface voids ratio TES for the tread, where TES=(AC−SC)/AC, in which the surface voids ratio TES is at least equal to 0.40 and at most equal to 0.70 for said tread. This surface voids ratio TES illustrates the level of voids (grooves, sipes) on the tread surface of the tread. Here it is relatively high because of the presence of a large number of oblique grooves 221 delimiting the blocks 21A, 21B. In addition, this surface voids ratio TES is increased by the presence of the inclined planes on the main walls of the blocks 21A, 21B and in part of the main sipes 211. The inclined planes on the tread when new thus limit the contact surfaces of the blocks 21A, 21B. In one preferred embodiment, the surface voids ratio TES is greater than or equal to 0.50. More preferably still, the surface voids ratio TES is greater than or equal to 0.55.

In another preferred embodiment, the ratio of the surface voids ratio TES to the volumetric voids ratio TEV is at least equal to 1.5 and at most equal to 1.9.

FIG. 8 is a schematic snapshot, at an instant T, of a contact patch AC of the tread of the tyre of FIG. 4, but at a certain level of wear. The tread wear is, for example, of the order of 2 mm of depth. In this state of wear, the inclined planes on the main walls of the blocks 21A, 21B and the main sipes 211A have disappeared from the tread. The oblique grooves 221 therefore exhibit a smaller width in this contact patch AC. As a result, the surface voids ratio TES decreases with the wearing of the tread. Thus, the surface voids ratio TES of the tread worn away by 2 mm of depth in comparison with the tread when new is at least equal to 0.41 times the surface voids ratio TES when new, and at most equal to 0.66 times said TES when new. In one preferred embodiment, the surface voids ratio TES of the tread worn away by 2 mm of depth in comparison with the tread when new is at least equal to 0.5 times the TES when new, and at most equal to 0.58 times said TES when new.

It is possible to determine a volumetric voids ratio TEV for the tread of FIG. 4 using the method described in FIG. 3. The grooves 221, the sipes 211 and 212 thus form voids in the tread, defining a voids volume VE in said tread. The ratio of the voids volume VE to the total volume VT determines a volumetric voids ratio TEV such that TEV=VE/VT. The volumetric voids ratio TEV here is at least equal to 0.24, and at most equal to 0.35.

In one preferred embodiment, the volumetric voids ratio TEV is at least equal to 0.25.

In one preferred embodiment, the volumetric voids ratio TEV is at least equal to 0.26.

In one preferred embodiment, the volumetric voids ratio TEV is at least equal to 0.27.

In one preferred embodiment, the volumetric voids ratio TEV is at least equal to 0.28.

In one preferred embodiment, the volumetric voids ratio TEV is at least equal to 0.29.

In one preferred embodiment, the volumetric voids ratio TEV is at least equal to 0.30.

In one preferred embodiment, the volumetric voids ratio TEV is at least equal to 0.31.

In one preferred embodiment, the volumetric voids ratio TEV is at least equal to 0.32.

In one preferred embodiment, the volumetric voids ratio TEV is at least equal to 0.33.

In one preferred embodiment, the volumetric voids ratio TEV is at least equal to 0.34.

It is therefore the designer of the tyre who has the opportunity to choose the volumetric voids ratio according to the desired compromise between grip on snowy ground and/or grip on wet ground and/or grip on dry ground.

FIG. 9 depicts part of the contact patch of FIG. 7, centred on a first block 21A and on a second block 21B positioned one on each side of the central axis C. The first block 21A and the second block 21B here form a pattern 26 which is specifically delimited by dotted lines in FIG. 7. The block patterns 26 succeed one another in the circumferential direction X at a pitch P in this instance of constant width. What is meant by a “pattern” is a collection of blocks which is repeated in the circumferential direction. This repeat may be an “iso-dimensional” repeat. The tread is then said to be monopitch. As an alternative, this repeat may be a repeat with different dimensions, notably different pitch values. The tread is then said to be multipitch. Advantageously, the number of different pitch values for a multi-pitch tread is comprised between 3 and 5.

In FIG. 9, the main sipe 211A of the first block 21A extends from the first edge 25A as far as one end of the first block 21A, near the central axis C. This main sipe 211A has a projected length lpy1 in the axial direction Y. In the same way, the main sipe 211B of the second block 21B extends from the second edge 25B as far as one end of the second block 21B, near the central axis C. This main sipe 211B has a projected length lpy2 in the axial direction Y. The lengths lpy1 and lpy2 here have identical values corresponding to half the width W of the tread. It is also possible to determine the projected lengths lpy3 and lpy4 of the secondary sipes 212A and 212B of the first block 21A and of the second block 21B. From these projected lengths it is possible to determine a sipes density SD. This sipes density corresponds to the ratio of the sum of the projected lengths lpy1, lpy2, lpy3 and lpy4 of the main sipes 211A, 211B and of the secondary sipes 212A, 212B in the axial direction Y to the product of the pitch P of the pattern 26 times the width W of the tread, all then multiplied by 1000, such that

$$SD = \frac{lpy 1 + lpy 2 + lpy 3 + lpy 4}{P * W} * 1000.$$

1000. The sipes density SD in the pattern 26 here is comprised between 10 mm⁻¹ and 70 mm⁻¹. According to one preferred embodiment, the sipes density SD in the pattern 26 is at least equal to 25 mm⁻¹ and at most equal to 50 mm⁻¹. As a preference, the sipes density SD in the pattern 26 is at least equal to 30 mm⁻¹ and at most equal to 40 mm⁻¹.

In another embodiment, the tread is a multi-pitch tread comprising a first pattern, a second pattern and a third pattern having three different pitch values P1, P2, P3. FIG. 10 illustrates this first pattern. FIG. 11 illustrates the second pattern. And finally, FIG. 12 illustrates the third pattern.

FIG. 10 thus illustrates a first pattern having a first pitch P1. This first pattern comprises the first block 21A and the second block 21B positioned one on each side of the central axis C. The main sipe 211A of the first block 21A extends from the first edge 25A as far as one end of the first block 21A, near the central axis C. This main sipe 211A has a projected length lpy11 in the axial direction Y. In the same way, the main sipe 211B of the second block 21B extends from the second edge 25B as far as one end of the second block 21B, near the central axis C. This main sipe 211B has a projected length lpy21 in the axial direction Y. The lengths lpy11 and lpy21 here have identical values corresponding to half the width W of the tread. It is also possible to determine the projected lengths lpy31 and lpy41 of the secondary sipes 212A and 212B of the first block 21A and of the second block 21B. From these projected lengths it is possible to determine a sipes density SD1. This sipes density corresponds to the ratio of the sum of the projected lengths lpy11, lpy21, lpy31 and lpy41 of the main sipes 211A, 211B and of the secondary sipes 212A, 212B in the axial direction Y to the product of the pitch P of the pattern 26 times the width W of the tread, all then multiplied by 1000, such that

$$SD 1 = \frac{lpy 11 + lpy 21 + lpy 31 + lpy 41}{P 1 * W} * 1000.$$

FIG. 11 thus illustrates a second pattern having a second pitch P2, in which the second pitch P2 is greater than the first pitch P1. This second pattern comprises the first block 21A and the second block 21B positioned one on each side of the central axis C. The main sipe 211A of the first block 21A extends from the first edge 25A as far as one end of the first block 21A, near the central axis C. This main sipe 211A has a projected length lpy12 in the axial direction Y. In the same way, the main sipe 211B of the second block 21B extends from the second edge 25B as far as one end of the second block 21B, near the central axis C. This main sipe 211B has a projected length lpy22 in the axial direction Y. The lengths lpy12 and lpy22 here have identical values corresponding to half the width W of the tread. It is also possible to determine the projected lengths lpy32 and lpy42 of the secondary sipes 212A and 212B of the first block 21A and of the second block 21B. From these projected lengths it is possible to determine a sipes density SD2. This sipes density corresponds to the ratio of the sum of the projected lengths lpy12, lpy22, lpy32 and lpy42 of the main sipes 211A, 211B and of the secondary sipes 212A, 212B in the axial direction Y to the product of the pitch P of the pattern 26 times the width W of the tread, all then multiplied by 1000, such that

$$SD 2 = \frac{lpy 12 + lpy 22 + lpy 32 + lpy 42}{P 2 * W} * 1000.$$

FIG. 12 illustrates a third pattern having a third pitch P3, in which the third pitch P3 is greater than the second pitch P2. This third pattern comprises the first block 21A and the second block 21B positioned one on each side of the central axis C. The main sipe 211A of the first block 21A extends from the first edge 25A as far as one end of the first block 21A, near the central axis C. This main sipe 211A has a projected length lpy13 in the axial direction Y. In the same way, the main sipe 211B of the second block 21B extends from the second edge 25B as far as one end of the second block 21B, near the central axis C. This main sipe 211B has a projected length lpy23 in the axial direction Y. The lengths lpy13 and lpy23 here have identical values corresponding to half the width W of the tread. It is also possible to determine the projected lengths lpy33 and lpy43 of the secondary sipes 212A and 212B of the first block 21A and of the second block 21B. From these projected lengths it is possible to determine a sipes density SD3. This sipes density corresponds to the ratio of the sum of the projected lengths lpy13, lpy23, lpy33 and lpy43 of the main sipes 211A, 211B and of the secondary sipes 212A, 212B in the axial direction Y to the product of the pitch P of the pattern 26 times the width W of the tread, all then multiplied by 1000, such that

$$SD 3 = \frac{lpy 13 + lpy 23 + lpy 33 + lpy 43}{P 3 * W} * 1000.$$

In the embodiment of FIGS. 10, 11 and 12, the tread comprises an arrangement of N1 patterns with pitch P1, of N2 patterns with pitch P2, and of N3 patterns with pitch P3. It is thus possible to determine a mean sipes density SDmean corresponding to the mean of the sipes densities SD1, SD2, SD3 of the patterns of pitch P1, P2, P3 over the entire circumference of the tread. The mean sipes density SDmean is thus weighted according to the number of patterns N1, N2, N3 per pattern type and the pitch P1, P2, P3, such that:

$$SDmean = \frac{( SD 1 * N 1 * P 1 + SD 2 * N 2 * P 2 + SD 3 * N 3 * P 3 )}{N 1 * P 1 + N 2 * P 2 + N 3 * P 3} .$$

The patterns of pitch P1, P2, P3 are arranged randomly on the tread so as to limit the emergence of tyre noise during running. Thus, for a tyre of size 205/55 R 16, patterns of pitch P1, P2 and P3 may be arranged relative to one another as follows: P1 P1 P2 P1 P2 P2 P2 P2 P1 P1 P2 P1 P1 P1 P2 P2 P3 P2 P2 P3 P2 P1 P2 P2 P1 P1 P1 P1 P2 P1 P2 P1 P1 P1 P1 P2 P1 P1 P2 P2 P3 P3 P3 P2 P2 P3 P3 P3 P3 P3 P2 P2 P1 P2 P2 P3 P2 P1 P2 P2 P1 P2 P3 P2 P2 P1 P2 P2 P2 P1 P1 P1 P2 P3 P2 P1. Such an arrangement would then comprise 21 patterns of pitch P1, 35 patterns of pitch P2 and 13 patterns of pitch P3. As has already been specified, a pitch P is determined as being the distance between the centres of two adjacent oblique grooves flanking a block. In order to determine, with precision, the values for the pitches P1, P2 and P3, these are measured in groups of patterns belonging to the same pattern type, for example in P1 P1 P1, P2 P2 P2 and P3 P3 P3 pattern groups.

Thus, with such a mutual arrangement of patterns, it is possible to determine a mean sipes density SDmean over the entire circumference of the tyre, with a value comprised between 10 mm⁻¹ and 70 mm⁻¹. In one preferred embodiment, the mean sipes density SDmean is at least equal to 25 mm⁻¹ and at most equal to 50 mm⁻¹. As a preference, the mean sipes density SDmean is at least equal to 30 mm⁻¹ and at most equal to 40 mm⁻¹.

For all the embodiments illustrated in FIGS. 1 to 12, each block is formed from a rubbery material. In one preferred embodiment, the composition of this rubbery material has a glass transition temperature comprised between −40° C. and −10° C. and preferably between −35° C. and −15° C. and a shear modulus measured at 60° C. comprised between 0.5 MPa and 2 MPa, and preferably between 0.7 MPa and 1.5 MPa.

In one preferred embodiment, the composition of the rubbery material of the blocks is based on at least:
an elastomer matrix comprising more than 50% by weight of a solution SBR bearing a silanol functional group and an amine functional group;
20 to 200 phr of at least one silica;
a coupling agent for coupling the silica to the solution SBR,
10 to 100 phr of a hydrocarbon-based resin having a Tg of greater than 20° C.;
15 to 50 phr of a liquid plasticizer.

The solution SBR in this preferred embodiment is a copolymer of butadiene and styrene, prepared in solution. The characteristic feature thereof is that it bears a silanol functional group and an amine functional group. The silanol functional group of the solution SBR bearing a silanol functional group and an amine functional group may for example be introduced by hydrosilylation of the elastomer chain by a silane bearing an alkoxysilane group, followed by hydrolysis of the alkoxysilane functional group to give a silanol functional group. The silanol functional group of the solution SBR bearing a silanol functional group and an amine functional group may equally be introduced by reaction of the living elastomer chains with a cyclic polysiloxane compound as described in EP 0 778 311. The amine functional group of the solution SBR bearing a silanol functional group and an amine functional group may for example be introduced by initiating polymerization using an initiator bearing such a functional group. A solution SBR bearing a silanol functional group and an amine functional group may equally be prepared by reacting the living elastomer chains with a compound bearing an alkoxysilane functional group and an amine functional group according to the procedure described in patent application EP 2 285 852, followed by hydrolysis of the alkoxysilane functional group to give a silanol functional group. According to this preparation procedure, the silanol functional group and the amine functional group are preferably situated within the chain of the solution SBR, not including the ends of the chain. The reaction producing the hydrolysis of the alkoxysilane functional group borne by the solution SBR to give a silanol functional group may be carried out according to the procedure described in patent application EP 2 266 819 A1 or else by a step of stripping the solution containing the solution SBR. The amine functional group can be a primary, secondary or tertiary amine functional group, preferably a tertiary functional group.

The invention is not limited to the embodiments and variants presented and other embodiments and variants will become clearly apparent to a person skilled in the art.

Thus, in FIG. 4, the blocks 21A, 21B are shown as being continuous from one edge of the tread 25A, 25B towards the central axis C. As an alternative, the blocks may be discontinuous. For example, the blocks may be interrupted by one or more grooves. The one or more grooves may have an orientation substantially equal to the orientation of the secondary sipes 212.

1.-19. (canceled)

20. A tire comprising a directional tread (10),
the tread (10) being intended to come into contact with a ground during running of the tire, forming a contact patch AC,
the tread comprising a plurality of blocks (21A, 21B) of rubbery material delimited by voids (221), some of the blocks (21A, 21B) forming a contact surface SC of the blocks (21A, 21B) in the contact patch AC,
a ratio of a difference between the contact patch AC and the contact surface of the blocks SC to the contact patch AC determining a surface voids ratio TES of the tread, where TES=(AC-SC)/AC,
the blocks (21A, 21B) being organized into patterns (26) of blocks of pitch P, the patterns (26) succeeding one another in a circumferential direction (X),
in a pattern comprising at least one sipe (211, 212), a ratio of a sum of projected length (lpyi) of the at least one sipe (211, 212) in an axial direction (Y) to a product of the pitch P of the pattern times a width (W) of the tread, all multiplied by 1000, determining a sipes density SD, such that
$$SD = \frac{{\sum }_{i = 1}^{n} lpyi}{P * W} * 1000 ,$$
where n is a number of sipes in the pattern (26), and lpyi is a projected length of an ith sipe,
wherein, when the tread is new, the sipes density SD in any pattern of pitch P is at least equal to 10 mm⁻¹ and at most equal to 70 mm⁻¹, and
wherein, when the tread is new, the surface voids ratio TES is at least equal to 0.40 and at most equal to 0.70.

21. The tire according to claim 20, wherein the surface voids ratio TES is greater than or equal to 0.45.

22. The tire according to claim 20, wherein the surface voids ratio TES is greater than or equal to 0.50.

23. The tire according to claim 20, wherein the surface voids ratio TES decreases with a depth of the tread (10).

24. The tire according to claim 23, wherein the surface voids ratio TES of the tread worn away by 2 mm of depth is at least equal to 0.41 times the TES when new and at most equal to 0.66 times the TES when new.

25. The tire according to claim 23, wherein the surface voids ratio TES of the tread worn away by 2 mm of depth is at least equal to 0.5 times the TES when new and at most equal to 0.58 times the TES when new.

26. The tire according to claim 20, wherein the tread comprises different pattern types Mj, where j is greater than or equal to 2, the patterns belonging to the one same pattern type having the one same pitch, the pitch between patterns belonging to two different respective pattern types being different, and
wherein a mean sipes density SDmean over an entire circumference of the tire is comprised between 10 mm⁻¹ and 70 mm⁻¹, the mean sipes density SDmean corresponding to a mean of sipes densities SDj of the patterns of the different pattern types Mj of pitch Pj over the entire circumference of the tread, the mean sipes density SDmean being weighted according to a number of patterns Nj per pattern type Mj and according to the pitch Pj of the patterns belonging to that pattern type Mj over the circumference of the tread, such that
$$SDmean = \frac{{\sum }_{j = 1}^{m} ( SDj * Nj * Pj )}{{\sum }_{j = 1}^{m} ( Nj * Pj )} ,$$
where m is a number of different pattern types, SDj is the sipes density in a pattern belonging to the pattern type Mj, Pj is the pitch of the patterns belonging to the pattern type Mj, and Nj is a number of patterns belonging to the pattern type Mj, when the tread is new.

27. The tire according to claim 26, wherein the sipes density SD or the mean sipes density SDmean is at least equal to 25 mm⁻¹ and at most equal to 50 mm⁻¹.

28. The tire according to claim 26, wherein the sipes density SD or the mean sipes density SDmean is at least equal to 30 mm⁻¹ and at most equal to 40 mm⁻¹.

29. The tire according to claim 20, wherein, in the tread when new, the blocks have a height at least equal to 5.5 mm and at most equal to 9 mm.

30. The tire according to claim 20, wherein a composition of the rubbery material of the blocks has a glass transition temperature Tg comprised between −40° C. and −10° C. and a complex dynamic shear modulus G* measured at 60° C. comprised between 0.5 MPa and 2 MPa.

31. The tire according to any one of claim 20, wherein the composition of the rubbery material of the blocks comprises an elastomer compound, the elastomer compound containing a modified diene elastomer containing at least one functional group comprising a silicon atom, the silicon atom being situated within a main chain of the elastomer, including the ends of the chain.

32. The tire according to claim 31, wherein the modified diene elastomer comprises a functional group containing a silicon atom at one end of the main chain of the elastomer.

33. The tire according to claim 32, wherein the functional group contains a silanol functional group.

34. The tire according to claim 33, wherein the functional group is selected from a silanol functional group or a polysiloxane functional group having a silanol end.

35. The tire according to claim 31, wherein the modified diene elastomer of the elastomer compound that makes up the block comprises a functional group containing a silicon atom in the middle of the chain.

36. The tire according to claim 31, wherein the silicon atom of the functional group is substituted by at least one alkoxy functional group which may potentially have been fully or partially hydrolyzed to hydroxyl.

37. The tire according to claim 35, wherein the silicon atom of the functional group is substituted directly or via a divalent hydrocarbon radical, by at least one other functional group containing at least one heteroatom selected from N, S, O, and P.

38. The tire according to claim 20, wherein the tire has a 3PMSF winter certification, the certification being indicated on a sidewall (30A, 30B) of the tire.
